(19) United States
(12) Patent Application Publication
(10) Pub. No.: US 2012/0317769 A1
(43) Pub. Date: Dec. 20, 2012

(54) STEERING BOX MOUNTING METHOD

(75) Inventors: Darren Trevor WAUGH, Victoria (AU); Warwick John DRENTH, Victoria (AU)

(73) Assignee: Hoi Lung Enterprise Limited

(21) Appl. No.: 13/475,197

(22) Filed: May 18, 2012

Related U.S. Application Data
(60) Provisional application No. 61/488,442, filed on May 20, 2011.

(30) Foreign Application Priority Data
May 13, 2011 (AU) 2011901815

(51) Int. Cl. B23P 23/00; B62D 1/16; F16M 13/02

(52) U.S. Cl. 29/401.1; 248/674; 74/492

(57) ABSTRACT

A method for converting the drive side of a vehicle. The method includes the step of mounting the steering box at (i) a horizontal angle of between 5 and 25 degrees and (ii) a vertical angle of 15 to 35 degrees relative to the straight portion of the vehicle chassis rails.

### CROSS-REFERENCE TO A RELATED APPLICATION

The present application claims priority based upon U.S. Provisional Application No. 61/488,442, filed May 20, 2011, which is incorporated herein by reference in its entirety.

### FIELD OF INVENTION

The present invention relates to the field of automotive engineering, more particularly steering assemblies for vehicles.

In one form, the invention relates to a device and method suitable for the conversion of vehicles from left-hand drive to right-hand drive and vice versa.

It will be convenient to hereinafter describe the invention in relation to utility trucks, however it should be appreciated that the present invention is not limited to that use only and has a much wider range of applications in the automotive industry.

### BACKGROUND ART

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

### Automotive Steering Assembly

An automotive steering assembly allows the driver to control the direction in which the vehicle travels. The steering assembly includes;

(i) a steering column, principally including a shaft having an upper end that supports a steering wheel for manual control by the driver,

(ii) a steering box located at a lower end of the steering column and in or adjacent to the engine bay of the vehicle,

(iii) steering gear consisting of a system of rods and levers connected between the steering box and the vehicle wheels; the steering gear pushes left or right to swivels the wheels, causing the vehicle to turn.

The steering box changes rotary movement of a steering wheel by the hands of the driver into linear motion of the vehicle wheels. The steering box linkage is typically either a rack and pinion system, or more commonly for trucks and SUVs, a recirculating ball steering system. A recirculating ball steering box contains a worm gear, comprising a block of metal with a threaded hole and gear teeth on its outer surface that engage a gear that moves a Pitman arm. The lower end of the steering column connects to a threaded rod that projects into the hole in the block. When the steering wheel turns, it turns the threaded rod. The threaded rod is fixed so that when it rotates it moves the block, which inturn moves the gear that turns the wheels. Instead of the threaded rod directly engaging the threads in the block, the threads are filled with ball bearings that recirculate through the gear as it turns. The ball bearings reduce friction and wear in the gear and keep the steering feeling ‘tight’ by ensuring they always maintain contact between the teeth.

The setup of the steering gear basically includes a drag link between the Pitman arm and a tie rod. A drag link transmits rotary motion between cranks on two parallel but slightly offset shafts. The tie rod is a metal arm that transmits motion to the vehicle (front) wheels.

### Drive Conversion

Vehicles are manufactured in either left-hand drive or right-hand configurations, the terms ‘left’ and ‘right’ referring to the placement of the driving seat and controls within the vehicle. Most countries have legislation that dictates whether cars in the relevant jurisdiction are left-hand or right-hand drive and it is common for imported cars to have drive conversion to comply with local law. Typically, countries in which cars drive on the left side of the road use right-hand drive vehicles, and countries in which cars drive on the right side of the road countries use left-hand drive vehicles.

The overall exterior appearance of most vehicles, particularly the chassis, is symmetrical about the longitudinal axis. However, this is not true of most of the interior mechanical fittings due to the placement of driving controls on the left or the right hand side of the vehicle. The lack of symmetry is particularly inconvenient when a vehicle is changed from left-hand to right-hand drive or vice versa because it is not necessarily possible to simply rotate components and re-fit them. Often they must be extensively re-engineered and re-positioned.

For example, large numbers of left-hand drive utility trucks are manufactured in the United States of America. The market for right-hand versions of these utility trucks is too small to justify manufacturing any as right-hand drive vehicles. Accordingly, when the left-hand drive utility trucks are exported to countries such as Australia and New Zealand, they must be converted to right-hand drive to comply with local law. During the drive conversion, left-hand parts have to be replaced with right-hand parts made from scratch because they are not available from the manufacturer. The need to manufacture parts tends to make the drive conversion very expensive.

This change from left-hand to right-hand drive raises particular problems with respect to steering assemblies systems. The steering assembly is not only of asymmetric shape, but must fit within the confines of the chassis and engine bay. In particular, there are a number of structural and safety elements that cannot be moved during the drive conversion because this would compromise the safety of the vehicle. In particular, many vehicles such as trucks have a frame comprising two parallel boxed or C-cross section rails (known as ‘chassis rails’), held together by cross beams (which together resemble a ladder). Typically a vehicle will have two straight portions of chassis rails on either side of the passenger compartment, adjacent the rocker panels located under each door. At either end, the chassis rails are no longer straight, but conform to the curve of the wheel arches. Vehicle safety legislation typically prohibits any changes to the frame that would be detrimental to its performance, particularly in an accident. Furthermore, the engine of most modern vehicles takes up most of the space in the engine bay, leaving very little room for maneuvering or repositioning vehicle components.

Due to the aforementioned limitations a steering assembly for a left-hand drive vehicle often cannot be re-fitted when the vehicle is converted to right-hand drive or vice versa.

Accordingly there is a need to address the problem of vehicle drive side change over, particularly with respect to the steering assembly.

### SUMMARY OF INVENTION

An object of the present invention is to provide a device to assist in the changeover of a vehicle from left-hand to right-hand drive or vice versa.

A further object of the present invention is to alleviate at least one disadvantage associated with the related art.

It is an object of the embodiments described herein to overcome or alleviate at least one of the above noted drawbacks of related art systems or to at least provide a useful alternative to related art systems.

In a first aspect of embodiments described herein there is provided a method for converting the drive side of a vehicle including the step of mounting the steering box at (i) a horizontal angle of between 5 and 25 degrees, and (ii) a vertical angle of 15 to 35 degrees, relative to the straight portion of chassis rails.

In a particularly preferred embodiment the method is used for the conversion of a left hand drive vehicle to a right hand drive.

The person skilled in the art will appreciate that the chassis rails are generally not perfectly straight or perfectly parallel in the vicinity of the passenger compartment and accordingly, some variation in angle measurement is to be expected.

Preferably the horizontal angle of the steering box is measured relative to the worm gear. In a particularly preferred embodiment the horizontal angle of the steering box is 10 to 20 degrees, more preferably about 15 degrees relative to the longitudinal axis defined by the straight portion of chassis rails.

Preferably the vertical angle of the steering box is measured relative to the worm gear. In a particularly preferred embodiment the vertical angle of the steering box is 20 to 30 degrees, more preferably about 26 degrees relative to the longitudinal plane defined by the longitudinal axis the chassis rails.

In a second aspect of embodiments described herein there is provided a bracket for locating the steering box, the bracket including at least one flange for attachment to the vehicle and at least one flange for mounting the steering box, wherein the bracket locates the steering box at (i) a horizontal angle of between 5 and 25 degrees, and (ii) a vertical angle of 15 to 35 degrees, relative to the straight portion of chassis rails.

Preferably the bracket has one or two flanges for attachment to the vehicle cross beam. Two flanges at slightly different angles may be necessary to allow for curving of the cross beam over the wheel arches. Typically the bracket includes multiple mounting means, such as holes in the flanges, so that the bracket may be bolted to the vehicle and the steering box. However it will be readily apparent to the person skilled in the art that the mounting may be carried out by any convenient means.

In a third aspect of embodiments described herein there is provided steering assembly modified according to a method as disclosed herein.

Typically, in a vehicle such as an SUV, the engine takes up the majority of space in the engine bay. A vehicle originally manufactured for left hand drive will also have many of its drive related components taking up much of the space in the left hand side of the engine bay and these will not necessarily be moved during the drive conversion. Immovable structural features such as chassis rails and cross beams further limit the ability to rearrange elements of the steering assembly. Accordingly, in a left hand to right hand drive conversion it may be possible to locate the steering box on the right hand side of the vehicle, typically in the space under the engine, adjacent the cross beam and between the engine and the chassis.

Other aspects and preferred forms are disclosed in the specification and/or defined in the appended claims, forming a part of the description of the invention.

In essence, embodiments of the present invention stem from the realization that it is possible to optimise the position of the steering box for the steering assembly of a drive conversion vehicle, despite space limitations and inherent asymmetry of the vehicle.

Advantages provided by the present invention comprise the following:
the existing steering box may be reused, thus avoiding the expense of custom making a new steering box;
the modified steering assembly can work with the existing, manufacturer installed electronic systems that assist in control of vehicle steering.

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 is a side plan view of vehicle illustrating the vertical angle and position of the steering box;

FIG. 2 is a top plan view of the vehicle of FIG. 1 illustrating the horizontal angle of the steering box;

FIG. 3 is a front perspective plan view of the vehicle of FIG. 1 illustrating the angle and position of the steering box;

FIG. 4 is a front view of one embodiment of a bracket according to the present invention for mounting the steering box; and

FIG. 5 is a top view of the bracket of FIG. 4.

### LIST OF PARTS REFERRED TO IN THE ILLUSTRATIONS

1 Vehicle

3 Chassis rail

5 Front bumper

7 Rear bumper

9 Steering box

11 Passenger compartment

13 Engine bay

15 Tray

17 Engine

19 Bracket for steering box

21 First flange

23 Second flange

25 Steering box mounting flange

27 Struts

### DETAILED DESCRIPTION

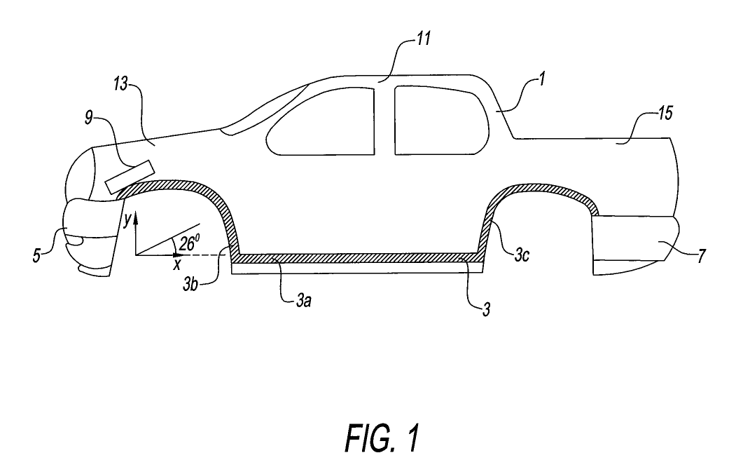

FIG. 1 is a side plan view of vehicle 1, more specifically a truck or SUV that has been converted from left hand drive to right hand drive. The vehicle 1 includes a frame comprising two parallel boxed rails known as chassis rails of which one chassis rail 3 can be seen in this view. The chassis rails are located on either side of the vehicle and are held together by cross bars (not visible). Typically a vehicle will have two straight portions of chassis rail 3a on either side of the passenger compartment 11, adjacent the rocker panels. At either end, the chassis rails 3b, 3c are no longer straight, but conform to the curve of the wheel arches. The chassis rails terminate inside the front bumper 5 and rear bumper 7 respectively. Vehicle safety legislation typically prohibits any changes to the frame that would be detrimental to its performance, particularly in an accident.

The steering box 9 is located in the engine bay 13 on the driver's side (right hand side) of the drive converted vehicle. In this view the vertical angle of the steering box 9 is about 26 degrees, relative to the straight portion of the chassis rails 3a adjacent the passenger compartment 11 of the vehicle. The two chassis rails define a plane lying along axes x and z, and the angle of the steering box 9 is its horizontal angle of elevation relative to that plane, or the longitudinal axis x.

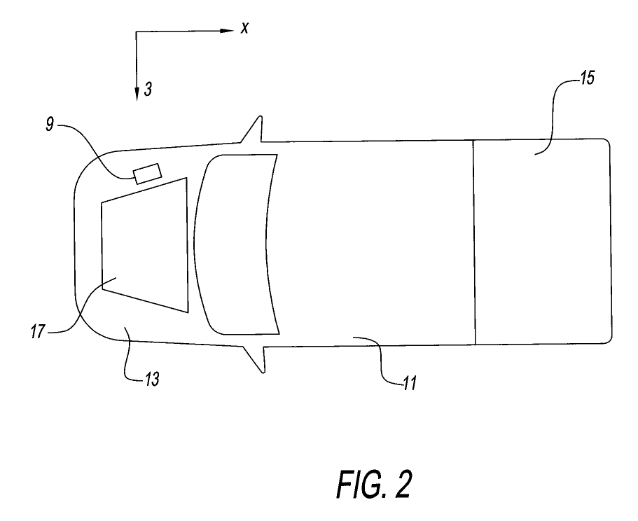

FIG. 2 is a top plan view of the vehicle of FIG. 1 illustrating the position of the steering box 9 on the driver's side of the vehicle, and the horizontal angle of the steering box 9. In this view the vertical angle of the steering box 9 is about 15 degrees, relative to the longitudinal axis (in this view the x-axis) defined by the straight portion of the chassis rails 3a adjacent the passenger compartment 11 of the vehicle.

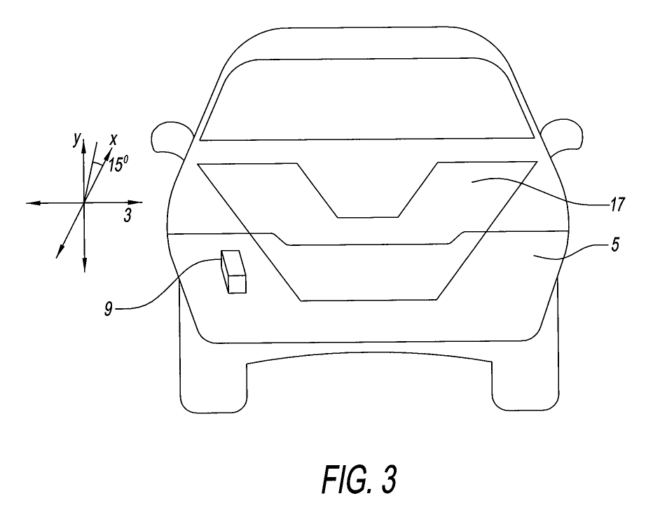

FIG. 3 is a front perspective plan view of the vehicle of FIG. 1 illustrating the angle and position of the steering box. In this view it is also possible to see the position of the steering box 9 relative to the engine 17 and the vehicle chassis. The steering box may be supported by a bracket of plate that is attached to the chassis.

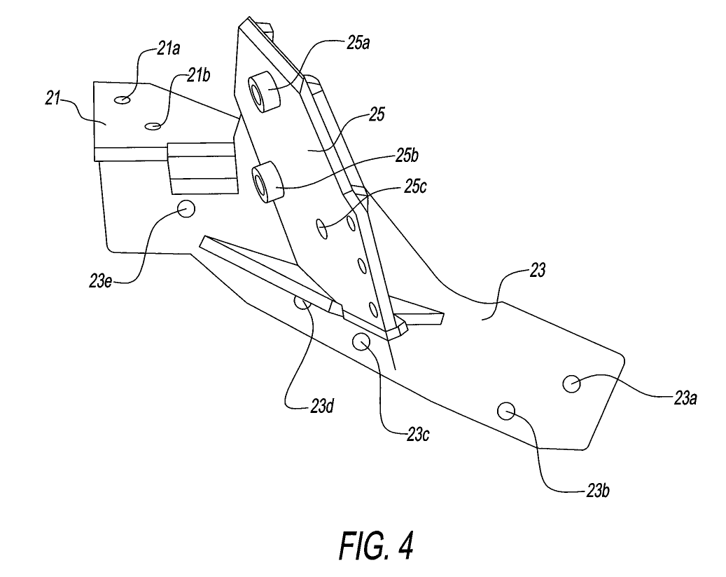

FIG. 4 is a front view of one embodiment of a bracket 17 according to the present invention for mounting the steering box. The bracket 17 includes a first flange 21, and a second flange 23 for attachment to the cross beam of a vehicle. The first flange 21 and second flange 23 each include holes (21a, 21b, 23a to 23e) for location of bolts to attach the bracket 17 to the cross beam. Optimally one or more of the holes (21a, 21b, 23a to 23e) align with holes included in the cross beam during manufacture. The bracket 17 further includes a steering box mounting flange 25 including three holes (25a, 25b, 25c) for use as mounting means for the steering box. In this embodiment mountings 25a and 25b including bushings. The overall shape of the bracket, flanges, holes and mounting means is configured to maintain the steering box at (i) a horizontal angle of between 5 and 25 degrees, and (ii) a vertical angle of 15 to 35 degrees, relative to the straight portion of chassis rails.

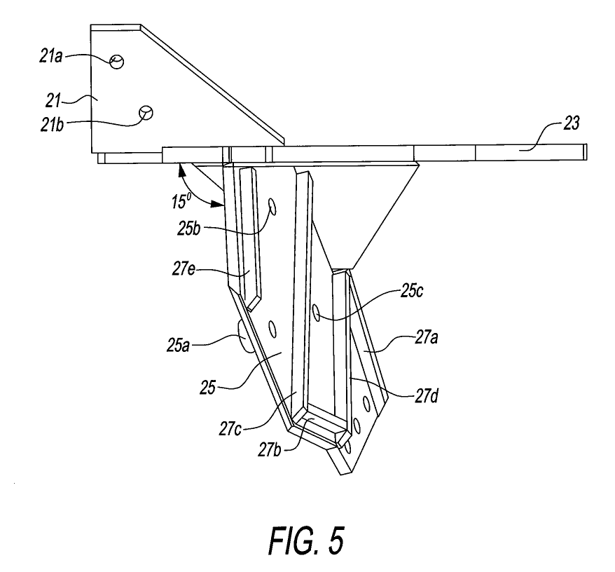

FIG. 5 is a top view of the bracket 17 of FIG. 4. This embodiment clearly shows an angle of 15 degrees between the first flange 23 and the steering box mounting flange 25 which would maintain the steering box at a horizontal angle of about 15 degrees. With this embodiment the vertical angle would be about 26 degrees. In this view support or reinforcing struts 27a to 27e can be clearly seen but these are not necessarily essential to proper functioning of the bracket 17.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures.

What is claimed is:

1. A method for converting the drive side of a vehicle including the step of mounting the steering box at (i) a horizontal angle of between 5 and 25 degrees, and (ii) a vertical angle of 15 to 35 degrees, relative to the straight portion of the vehicle chassis rails.

2. The method according to claim 1, wherein the method is used for the conversion of a left hand drive vehicle to right hand drive.

3. The method according to claim 1, wherein the horizontal angle of the steering box is 10 to 20 degrees, more preferably about 15 degrees relative to the longitudinal axis defined by the straight portion of chassis rails.

4. The method according to claim 1, wherein the vertical angle of the steering box is 20 to 30 degrees, more preferably about 26 degrees relative to the longitudinal plane defined by the longitudinal axis the chassis rails.

5. The method according to claim 1, further including the step of attaching a mounting bracket to a cross beam of the vehicle, wherein the mounting bracket includes at least one flange for attachment to the vehicle and at least one flange for mounting the steering box wherein the bracket locates the steering box at (i) a horizontal angle of between 5 and 25 degrees and (ii) a vertical angle of 15 to 35 degrees relative to the straight portion of the vehicle chassis rails.

6. A bracket for mounting the steering box of a vehicle, the bracket including at least one flange for attachment to the vehicle and at least one flange for mounting the steering box wherein the bracket locates the steering box at (i) a horizontal angle of between 5 and 25 degrees, and (ii) a vertical angle of 15 to 35 degrees, relative to the straight portion of the vehicle chassis rails.

7. A steering assembly modified according to the method as set forth in claim 1.
